(19) United States
(12) Patent Application Publication
(10) Pub. No.: US 2011/0006239 A1
(43) Pub. Date: Jan. 13, 2011

(54) PREASSEMBLED VALVE ASSEMBLY FOR USE IN A TURBOCHARGER

(75) Inventors: Torsten GERLICH, Bensheim (DE); Joerg BITTNER, Laudenbach (DE)

Correspondence Address: Leydig, Voit & Mayer, Ltd. (Frankfurt office), Two Prudential Plaza, Suite 4900, 180 North Stetson Avenue, Chicago, IL, 60601-6731, US

(73) Assignee: CARL FREUDENBERG KG, Weinheim (DE)

(21) Appl. No.: 12/833,363

(22) Filed: Jul. 9, 2010

(30) Foreign Application Priority Data
Jul. 9, 2009 (DE) 10 2009 032 685.5

(51) Int. Cl. F16K 1/00

(52) U.S. Cl. 251/331

(57) ABSTRACT

A valve assembly disposable in a turbocharger housing includes a cover; a sealing body connected to the cover so as to form a pressure space between the cover and the sealing body; a restoring spring disposed in the pressure space and disposed against the cover and the sealing body, wherein the sealing body is moveable relative to the cover counter to the force of the restoring spring; and a diaphragm connecting the cover and the sealing body to each other, wherein the diaphragm at least partly surrounds the sealing body.

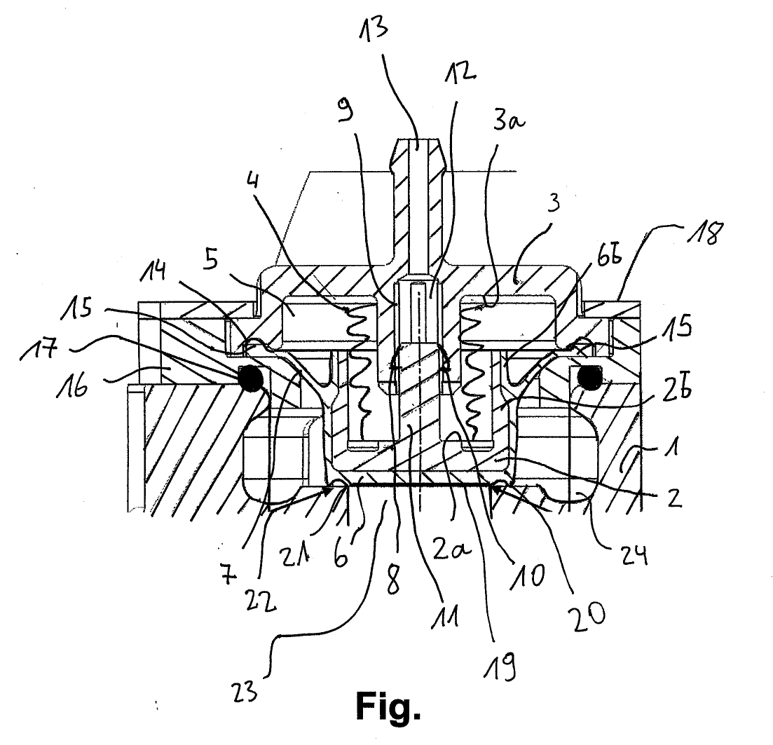

### CROSS REFERENCE TO PRIOR APPLICATIONS

Priority is claimed to German Patent Application No. DE 10 2009 032 685.5, filed Jul 9, 2009, the entire disclosure of which is incorporated by reference herein.

### FIELD

The invention relates to a valve assembly to be arranged in the housing of a turbocharger, comprising a sealing body and a cover, the sealing body being movable relative to the cover counter to the force of a restoring spring, the cover and the sealing body forming a pressure space in which the restoring spring is accommodated, and the restoring spring resting against the cover and against the sealing body.

### BACKGROUND

Valve arrangements in which valve assemblies of the type mentioned at the outset are arranged are known in the art. The valve assemblies known in the art have the drawback of having first to be incorporated into the housing of a valve in order to be able to test that the assemblies are working properly.

In particular in housings which are part of a motor or unit, it is in many cases possible to test that the valve assembly is working properly only once the assembly has been fitted. A particular drawback of this is the fact that factory-delivered valve assemblies may be defective, but the defectiveness becomes apparent only once the valve assembly has been fitted. This involves complex reworking and fault corrections which can lead to product recalls and considerable costs.

### SUMMARY OF THE INVENTION

The invention is therefore based on the object of disclosing a valve assembly which can be incorporated without difficulty into an existing housing and displays very low susceptibility to faults.

According to this, the valve body mentioned at the outset is characterised in that the cover and the sealing body are connected to each other by a diaphragm which at least partly surrounds the sealing body.

According to the invention, it has been recognised that this specific configuration allows the valve assembly consisting of the cover, sealing body, restoring spring and diaphragm to be inserted into a housing of a valve as a preassembled structural unit. In particular, it has been recognised that a valve assembly preassembled in this way can be reliably manufactured and tested at the site of production in order to be then incorporated into a stationary housing elsewhere. In particular, it has been recognised that the captive connection of the cover and the sealing body provides a preassembled valve assembly which can be tested at the site of production and then transported to the site of use. The tested preassembled valve assembly then displays low susceptibility to faults at the site of use. The object mentioned at the outset is accordingly achieved.

Against this background, the diaphragm could be formed in a bag or cup-like manner and accommodate the sealing body, the diaphragm having a protruding rim which is connected to the cover. This specific configuration allows the diaphragm to enclose and captively mount a likewise cup-like or cylindrically formed sealing body. The rim forms a region which is deformable without difficulty and ensures that the sealing body is reversibly movable relative to the cover. The rim can for example be configured as part of a rolling diaphragm.

The cover and the sealing body could be captively connected to each other via catch means. This configuration ensures that the cover and the sealing body can permanently enclose the restoring spring between them. The restoring spring cannot be brought out of its operating position during transportation. Furthermore, the catch means ensure that although the cover and the sealing body are reversibly movable relative to each other, they cannot be separated from each other in a non-destructive manner. The catch means also allow the sealing body to be removed from the cover only up to a certain distance.

In this case, the catch means could be configured as catch lugs of the sealing body that are mounted so as to be slidingly movable in a guide of the cover and can be placed against a rest of the guide. The sliding guidance of the catch lugs in a guide of the cover ensures that the sealing body moves relative to the cover along an axis and does not perform any lateral tiltings or yielding movements. A rest, which is shaped in or on the guide of the cover, allows a stop to be formed for the catch lugs of the sealing body, so that the sealing body can be removed only up to a certain distance from the cover.

A feed line to the pressure space could be formed in the cover. This specific configuration allows the build-up in the pressure space of a first pressure which defines, together with the force of the restoring spring, an opening point of the sealing body arranged in a valve. The sealing body could then rise from a sealing seat if the pressure acting thereon out of a flow channel is greater than the sum of the force of the pressure in the interior of the pressure space and the force of the restoring spring. To this extent, it is possible to provide a pneumatically operating divert air valve, the opening and closing behaviour of which is determined solely by the pressures acting on the sealing body and the spring constant of the restoring spring.

A groove could be formed in the cover for accommodating the diaphragm. This specific configuration ensures reliable sealing of the pressure space. Furthermore, the groove can be formed in such a way that a bead-like protuberance is accommodated at the edge of the rim of the diaphragm with a fit in the groove.

Against this background, the rim of the diaphragm could be mounted between a clamping body and the cover. The formation of a clamping body on the one hand allows the diaphragm to be securely connected to the cover and on the other hand can serve as an assembly aid when the preassembled valve assembly is inserted into the housing of a valve. In this case, the clamping body is also part of the preassembled valve assembly.

A face, on which at least one peripheral sealing lip is formed, could be formed on the diaphragm. It is also conceivable for two concentrically arranged peripheral sealing lips to be formed on the face of the diaphragm. This allows the diaphragm to be placed against a sealing seat in the housing of the valve so as to produce a reliable seal. The formation of two sealing lips increases the fluid-tight sealing of a first flow channel from a second flow channel in the housing of the valve.

The valve assembly described in the present document could be inserted into a housing of a valve as a preassembled structural unit. In order to avoid repetitions, reference may be made with regard to inventive step to the discussion of the valve assembly per se.

The sealing body could be placed against a sealing seat, the diaphragm being interposed, in such a way that a first flow channel is separated off from a second flow channel in a fluid-tight manner. Against this background, the valve could be configured as a pneumatic divert air valve of a turbocharger. The preassembled valve assembly is suitable for special use in a turbocharger, as although a turbocharger is already assembled in a motor vehicle, the preassembled valve assembly can be reliably incorporated and exchanged on site afterwards.

There are then various possibilities for configuring and developing the teaching of the present invention in an advantageous manner. In this regard, reference may be made on the one hand to the dependent claims and on the other hand to the following description of a preferred exemplary embodiment given with reference to the drawing.

Generally preferred configurations and developments of the teaching will also be described in conjunction with the description of the preferred exemplary embodiment of the invention given with reference to the drawing.

### BRIEF DESCRIPTION OF THE DRAWING

In the drawing, the sole FIGURE is a sectional view of a partly shown compressor housing of a turbocharger in which the preassembled valve assembly is inserted.

### DETAILED DESCRIPTION

The sole FIGURE shows a preassembled valve assembly which is inserted as a structural unit into a housing 1 which forms a valve together with the preassembled valve assembly. The housing 1 is configured as a compressor housing of a turbocharger.

The valve assembly comprises a sealing body 2 and a cover 3, the sealing body 2 being movable relative to the cover 3 counter to the force of a restoring spring 4. The cover 3 and the sealing body 2 form a pressure space 5 in which the restoring spring 4 is accommodated. The pressure space 5 is delimited by the cover 3 and the sealing body 2. The restoring spring 4 rests at one end against the cover 3 and at the other end against the sealing body 2. The restoring spring 4 rests against an annular contact face 2a of the cover 3. Furthermore, the other end of the restoring spring 4 rests against an annular contact face 2a of the sealing body 2.

The cover 3 and the sealing body 2 are connected to each other by a diaphragm 6 which at least partly surrounds the sealing body 2. The diaphragm 6 delimits the pressure space 5 together with the sealing body 2 and the cover 3. The volume of the pressure space 5 is therefore variable.

The diaphragm 6 is formed in a bag or cup-like manner in cross section and accommodates the sealing body 2 which is likewise formed in a cup-like manner in cross section. In this case, the diaphragm 6 has a protruding rim 7 which is connected to the cover 3. The diaphragm 6 completely encloses the sealing body 2 all the way round. The sealing body 2 has a peripheral shoulder 2b around which the diaphragm 6 is placed in order to open into an annular portion 6b which is aligned with the upper edge of the sealing body 2. The rim 7 of the diaphragm 6 protrudes from the annular portion 6b.

The cover 3 and the sealing body 2 are captively connected to each other via catch means 8. The catch means are configured as a peripheral catch lug which is mounted so as to be slidingly movable in a guide 9 of the cover 3 and can be placed against a rest 10 of the guide 9. The catch lug protrudes from a pin 11 which is arranged coaxially with the cover and is shaped in one piece from the sealing body 2. The guide 9 of the cover 3 is likewise configured in a pin-shaped manner with a central hole 12. The pin 11 is mounted in a slidingly movable manner in the central hole 12 together with the catch lug.

A feed line 13, which is formed coaxially with the hole 12, is formed in the cover 3. The feed line 13 is connected to the pressure space 5 in a fluid-conducting manner.

A groove 14, which accommodates a bead-like protrusion or thickening 15 of the rim 7 of the diaphragm 6, is formed in the cover 3. The bead-like thickening 15 and parts of the rim 7 respectively are mounted between a clamping body 16 and the cover 3. The clamping body 16 is sealed from the housing 1 by the positioning of a ring seal 17. A flange 18 presses the clamping body 16 together with the cover 3 against the housing 1 and connects them thereto.

The diaphragm 6 forms a face 19 on which at least one peripheral sealing lip 20 is formed. In the specific exemplary embodiment, two coaxially concentrically arranged sealing lips 20 and 21 are formed.

The valve assembly is inserted as a preassembled structural unit into a housing 1 which forms a valve together with the valve assembly. In this case, the sealing body 2 can be placed against a sealing seat 22, the diaphragm 6 being interposed, in such a way that a first flow channel 23 is separated off from a second flow channel 24 in a fluid-tight manner.

If the pressure in the flow channel 23 generates on the sealing body 2 a force which is greater than the force of the restoring spring 4 and the force of the pressure in the pressure space 5, then the sealing body 2 rises from the sealing seat 22 and connects the first flow channel 23 to the second flow channel 24 in a fluid-conducting manner.

With regard to further advantageous configurations and developments of the teaching according to the invention, reference is made on the one hand to the general part of the description and on the other hand to the claims.

Finally, it should be emphasised most particularly that the exemplary embodiment selected hereinbefore serves merely for discussion of the teaching according to the invention, but does not limit the teaching to this exemplary embodiment.

What is claimed is:

1. A valve assembly disposable in a turbocharger housing comprising:
a cover;
a sealing body connected to the cover so as to form a pressure space between the cover and the sealing body;
a restoring spring disposed in the pressure space and disposed against the cover and the sealing body, wherein the sealing body is moveable relative to the cover counter to the force of the restoring spring; and
a diaphragm connecting the cover and the sealing body to each other, wherein the diaphragm at least partly surrounds the sealing body.

2. The valve assembly as recited in claim 1, wherein the valve assembly is a preassembled structural unit.

3. The valve assembly as recited in claim 1, wherein the diaphragm is formed in one of a bag and a cup-like manner so as to accommodate the sealing body, and wherein the diaphragm includes a protruding rim connected to the cover.

4. The valve assembly as recited in claim 1, further comprising a catch configured to connect the cover and the sealing body.

5. The valve assembly as recited in claim 4, wherein the catch includes a catch lug of the sealing body mounted so as to be slidingly movable in a guide of the cover and placeable against a rest of the guide.

6. The valve assembly as recited in claim 1, wherein the cover includes a feed line operatively communicating with the pressure space.

7. The valve assembly as recited in claim 1, wherein the cover includes a groove accommodating the diaphragm.

8. The valve assembly as recited in claim 3, further comprising a clamping body, wherein the protruding rim is disposed between the clamping body and the cover.

9. The valve assembly as recited in claim 1, wherein the diaphragm includes a face having at least one peripheral sealing lip.

10. The valve assembly as recited in claim 1, further comprising a housing, the sealing body being disposed in the housing.

11. The valve assembly as recited in claim 10, wherein the housing includes a sealing seat, sealing body being placeable against the sealing seat so as to separate a first flow channel from a second flow channel in a fluid-tight manner.
